(19) United States
(12) Patent Application Publication
(10) Pub. No.: US 2022/0400236 A1
(43) Pub. Date: Dec. 15, 2022

(54) OPTICAL SYSTEM FOR A VIRTUAL RETINAL SCAN DISPLAY, DATA GLASSES AND METHOD FOR PROJECTING IMAGE CONTENTS ONTO THE RETINA OF A USER

(71) Applicant: Robert Bosch GmbH, Stutlgart (DE)

(72) Inventor: Gael Pilard, Wankheim (DE)

(73) Assignee: Robert Bosch GmbH, Stuttgart (DE)

(21) Appl. No.: 17/833,541

(22) Filed: Jun. 6, 2022

(30) Foreign Application Priority Data
Jun. 15, 2021 (DE) 10 2021 206 073.0

(51) Int. Cl. H04N 9/31; G02B 26/08; G02B 26/10; G02B 27/00

(52) U.S. Cl. CPC H04N 9/3129; G02B 26/0833; G02B 26/105; G02B 27/0081; H04N 9/315; H04N 9/3188

(57) ABSTRACT

An optical system for a virtual retinal scan display. The optical system includes: a projector unit including a modulatable light source for generating at least one modulated light beam and including a movable deflection device for the light beam, a scanning projection of an image content being generatable from the at least one light beam as a result of the movement of the movable deflection device; a diverting unit, onto which the image content is projectable and which is configured to map the projected image content into an exit pupil and to guide it onto an eye of a user; an optical exit pupil shifting unit situated in an optical path of the light beam for spatially shifting the exit pupil of an eye box of the optical system in directions which extend at least essentially in parallel to an exit pupil plane of the exit pupil.

### CROSS REFERENCE

The present application claims the benefit under 35 U.S.C. § 119 of German Patent Application No. DE 10 2021 206 073.0 filed on Jun. 15, 2021, which is expressly incorporated herein by reference in its entirety.

### BACKGROUND INFORMATION

Data glasses such as, for example, “Google Glasses,” are described in the related art. One conventional display method for such data glasses is the so-called retinal scan display described in U.S. Patent Application Publication No. US 2015/0362734 A1, which may include holographic optical elements (HOE) as imaging elements.

### SUMMARY

The present invention is directed to an optical system for a virtual retinal scan display. In accordance with an example embodiment of the present invention, the optical system includes at least one projector unit including a modulatable light source for generating at least one modulated light beam and including one movable deflection device for the at least one light beam, a scanning projection of an image content being generatable from that at least one light beam as a result of the movement of the movable deflection device, and at least one diverting unit, onto which the image content is projectable and which is configured to map the projected image content into an exit pupil and to guide it onto an eye of a user.

In accordance with an example embodiment of the present invention, it is provided that the optical system includes an optical exit pupil shifting unit situated in an optical path of the light beam for the manual or at least semi-automated spatial shifting of the exit pupil, and in particular, of an eye box of the optical system, preferably in directions which extend at least essentially in parallel to an exit pupil plane of the exit pupil. This may enable an advantageous spatial adjustability of an exit pupil position and/or of an eye box position. A viewing experience may advantageously be significantly improved. It may be advantageously ensured that an image remains visible even with a shifting of the data glasses or with an eye movement of the user. A simple adaptation to different user physiognomies (“one size fits all”) may be advantageously achieved. A particularly large effective total eye box may be advantageously achieved. An “effective total eye box” is understood to mean a spatial range of pupil positions of a user eye, in which the entire image content from at least one exit pupil of the virtual retinal scan display (RSD) is able to reach through the pupil of the user eye.

A “virtual retinal display” may be understood to mean a retinal scan display or a light field display, in which the image content may be scanned sequentially by the deflection of at least one light beam, in particular, of a laser beam of at least one temporally modulated light source such as, for example, one or multiple laser diodes, and is mapped by optical elements directly onto the retina of the user eye. The modulation of the light source takes place, in particular, on the basis of an image data output of an image source. The image source is designed, in particular, as an electronic image source, for example, as a graphic output, in particular, a (integrated) graphic map, of a computer or processor or the like. The image source may, for example, be integrally designed with a, for example, image processing unit of the optical system that dynamically modifies the output image data. Alternatively, the image source may be designed separately from the image processing unit and may convey the image data to the image processing unit of the optical system. The image data are designed, in particular, as color image data, for example, RGB image data. The image data may be designed, in particular, as still images or as moving images, for example, as videos. The image data are designed, in particular, for the purpose of enabling a representation of an image content to be mapped. The image processing unit is provided preferably for the purpose of modifying, in particular, distorting, copying, skewing, off-setting, scaling or the like the image data of the image source. The image processing unit is designed preferably for the purpose of generating copies of the image content, which are, in particular, modified, for example, distorted, skewed, offset and/or scaled.

In accordance with an example embodiment of the present invention, the projector unit is configured, in particular, to radiate the image content from the image data in the form of scanned and/or rasterized light beams. The projector unit includes, in particular, the movable deflection device. The movable deflection device may be designed as a MEMS mirror (micro-mirror actuator), in particular, at least for the controlled deflection of the at least one light beam of the light source of the projector unit. The MEMS mirror in this case may be movable/pivotable in two dimensions. Alternatively, the MEMS mirror may also be formed from two successively connected 1-D mirrors. Alternatively or in addition, the deflection device includes at least one connectable diffractive optical element in the form of a phase modulator and/or intensity modulator, which may be designed, for example, as a spatial light modulator (SLM) with a reflective design, for example, with a DMD or LCoS design, or with a transmissive design, for example, as an LCD. The temporally modulatable light source, in particular, is analog-modulated, an alternative TTL modulation, for example, also not being ruled out, however. The diverting unit includes, in particular, an arrangement of optical elements, for example, diffractive, reflective, refractive and/or holographic optical elements. However, the diverting unit preferably always includes at least one holographic optical element. The diverting unit is preferably at least partially integrally formed in at least one lens of data glasses. It is also possible, of course, that each lens of the data glasses includes a holographic optical element. The diverting lens is provided, in particular, for the purpose of diverting merely a portion of the intensity of the projected image content onto the user eye. At least one further portion of the intensity of the projected image content passes through the diverting unit. The diverting unit appears essentially transparent to a user, as viewed at least from a perpendicular viewing direction. The diverting unit forms, in particular, a projection area. The projection area forms, in particular, an area within which a light beam, when it strikes the diverting unit, is deflected/diverted in the direction of the user eye, in particular, in the direction of an eye pupil area of the optical system.

An “eye pupil” (Ramsden circle) is understood to mean, in particular, an image-side image of a (virtual) aperture diaphragm of the optical components of the optical system generating the image of the image content. In one intended use of the optical system, in particular, at least one of the exit pupils of the optical system overlaps with an entrance pupil of the user eye. The image content (or the respective mapping of the image content) situated preferably in a (virtual) entrance pupil of the optical components of the optical system is, in particular, mapped in the exit pupil. The exit pupil of the optical system forms, in particular, at least one part of an eye box. A diameter of the exit pupil is, in particular, smaller than an average diameter, preferably smaller than a minimum diameter of the entrance pupil of the user eye. An “eye box” in this case is understood to mean a spatial area within which all light beams of the scanning projection are able to pass the entrance pupil of the user eye. The spatial position of the exit pupil may be changed with the aid of the exit pupil shifting unit manually, for example, via a switch, adjusting dial or the like, or in an automated manner, for example, with the aid of an automatically controlled solenoid actuator or the like. The exit pupil plane may extend at least essentially in parallel with a lens of the data glasses. The optical exit pupil shifting unit includes, in particular, at least one optical element or a combination of multiple optical elements. The individual or combined optical elements may each be designed as diffractive optical elements and/or as reflective optical elements and/or as refractive elements, which act in particular, in an optically focusing and/or optically deflecting manner. It is possible that the spatial displacement of the exit pupil position is achieved by a spatial shift of at least one sub-component, in particular, of at least one optical element of the optical exit pupil shifting unit and/or by a manipulation of intrinsic optical characteristics of at least one sub-component, in particular, of at least one optical element of the optical exit pupil shifting unit such as, for example, a change of a refraction angle, of a refraction index, of a reflection angle, etc., for example, controlled by a mechanical change of shape or by applying an electrical signal such as a voltage.

In accordance with an example embodiment of the present invention, it is further provided that the optical exit pupil shifting unit is situated in the optical path of the light beam between the light source and the movable deflection device. An advantageous implementation of an optical system shifting the exit pupil position may be enabled as a result. A particularly space-saving implementation of the optical exit pupil shifting unit may be advantageously achieved, in particular, since the light beam in front of the deflection device still has a particularly small cross section. With a more compact design of the optical exit pupil shifting unit, it is advantageously possible to achieve a lower weight and with an automated activation, a lower energy consumption. It is possible, in particular, that a MEMS control or an actuator system identical to a MEMS control may be used for a manipulation/movement of at least one optical element of the exit pupil shifting unit. In addition, a higher resolution may be advantageously achieved in this case, since a shift/distortion of the projected image content on the retina may be kept particularly small in this case. It is possible that at least the light source, the optical exit pupil shifting unit and the movable deflection device are housed in a shared projector housing.

It is also provided that the optical exit pupil shifting unit is designed as an, in particular, single focal lens. In this way, advantageous characteristics with respect to the shift of the spatial position of the exit pupil may be achieved. A compact and, in particular, structurally uncomplicated (optionally currentless) implementation of the exit pupil shifting unit may be advantageously enabled. The focal lens is provided, in particular, for the purpose of spatially shifting a point of incidence of the light beam exiting the light source on the movable deflection unit. This shift is implemented by the optical system in a spatial shift of the point of incidence of the projected light beam scanned with the aid of the movable deflection unit on the diverting unit and thus in the spatial shift of the exit pupil position. A focal lens acts on the light beam, in particular, in a focusing manner. A slightly acentric striking of the light beam on the focal lens also results, in addition to the focusing, in a smaller deflection of the light beam from a straight beam direction.

In this context, it is provided that the focal lens is displaceably mounted for generating the spatial shift of the exit pupil in at least one plane, which is extended at least essentially perpendicularly to a propagation direction of the light beam in an area of the optical system situated (directly) in front of the focal lens. In this way, the spatial shift of the point of incidence of the light beam on the movable deflection device and the related advantageous effects with respect to a shift of the exit pupil may be advantageously achieved. The expression “essentially perpendicularly” is intended here to define, in particular, an orientation of a direction relative to a reference direction, the direction and the reference direction, viewed, in particular, in a projection plane, encompassing an angle of 90°, and the angle having a maximum deviation, in particular, of less than 8°, advantageously less than 5° and particularly advantageously less than 2°. An area situated in front of the lens is understood, in particular, to mean an area of the optical system situated in the beam direction of the light beam in front of the focal lens/an area of the optical system situated upstream of the beam relative to the focal lens.

In accordance with an example embodiment of the present invention, it is also provided that the focal lens is displaceably mounted for focusing the image content mapped in the exit pupil at least in a direction that extends at least essentially in parallel to a propagation direction of the light beam in the area of the optical system (directly) in front of the focal lens. In this way, an additional, in particular, particularly simple and space-saving and cost-saving focusing option may be advantageously created. This may also advantageously compensate for a slight defocusing produced by a shift of the focal lens perpendicularly to the propagation direction of the light beam. This may advantageously enable a sharpness of the projected image content to be corrected. In addition, an actuator system, which is already used for shifting the exit pupil position, may also be advantageously used for correcting the sharpness. A high degree of compactness may be achieved as a result.

Alternatively or in addition, it is provided that the optical exit pupil shifting unit is situated in the optical path of the light beam between the movable deflection device and the diverting unit. A preferably small aperture of the projector unit and/or a small spatial extension of the deflection direction, in particular, of the MEMS mirror (small MEMS aperture) may be advantageously achieved. In this way, costs, in particular, for the MEMS system may be advantageously held to a minimum. The optical exit pupil shifting unit situated in such a way is situated, in particular, within a close range of a beam outlet of the projector unit or within the projector unit, for example, within the shared projector housing. A close range in this context is understood to mean, in particular, an area formed by points, whose points are all less than 2 cm, preferably less than 1 cm, and preferably less than 0.5 cm away from the beam outlet of the projector unit. The beam outlet is designed, in particular, as an opening in the projector housing. The exit pupil shifting unit situated between the movable deflection device and the diverting unit forms, in particular, a part of the projection optical system and/or of an objective lens of the projector unit.

In accordance with an example embodiment of the present invention, it is additionally provided that the optical exit pupil shifting unit is designed as a multi-lens lens system including at least one first lens and including at least one second lens, the second lens being situated in the optical path of the light beam downstream from the first lens and, in particular, in parallel to the first lens. This may advantageously enable a simple design of a mechanically manipulatable optical exit pupil shifting unit. The lenses each have, in particular, focal lengths in the lower centimeter range. The multi-lens lens system has a focal length, in particular, of a few centimeters, for example in a range between 5 cm and 25 cm, in particular, 15 cm. The lenses are each designed, in particular, as thin lenses.

A simple and effective spatial shift of the exit pupil may be advantageously achieved if, in order to produce the spatial shift of the exit pupil, the first lens of the multi-lens system is displaceably mounted at least in a plane extending at least essentially in parallel to a main extension plane of the first lens. A “main extension plane” of an element is understood to mean a plane, which extends in parallel to a largest lateral surface of a smallest possible cuboid, which only just completely encloses the element and, in particular, runs through the midpoint of the cuboid. A distance between the two lenses remains, in particular, at least essentially the same in the case of a lateral shift of the first lens. The second lens remains, in particular, at least essentially immobile during the shift of the first lens. The first lens is, in particular, (laterally) displaceably mounted relative to the second lens.

In accordance with an example embodiment of the present invention, it is further provided that the optical exit pupil shifting unit is designed as a phased array optical system, in particular, as a phased array optical element. An optical exit pupil shifting unit unaffected by mechanical position changes and/or of mechanical actuators may thereby be advantageously. A compact design may be advantageously enabled as a result. The phased array optical system is provided, in particular, for the purpose of manipulating a deflection, preferably a deflection angle, of the light beam as a function of an electrical signal (current/voltage) applied to the phased array optical system. With the aid of the technology of the phased array optical system, it is possible to guide the direction of light beams that exit the phased array optical element by dynamically controlling optical characteristics of a surface on a microscopic scale. The phased array optical element may be designed, in particular, as an optical phased array transmitter, which may replace or form, in particular, the light source of the projector unit and, optionally, also the movable deflection device of the projector unit. The optical phased array transmitter includes, in particular, a light source (laser), a power splitter, a phase shifter and an array of radiator elements. The output light of the laser source in the phased array transmitter, in particular, is divided into multiple branches using a power splitter tree in such a way that each branch is fed to an adjustable phase shifter. The light phase-shifted in this way is then fed to a radiating element (for example, to a nanophotonic antenna), which couples the light into the open space. The light radiated by the elements is combined in the far-field and forms the far-field pattern of the phased array optical element. By adjusting the relative phase shift between the elements, it is possible to form and guide the light beam.

In accordance with an example embodiment of the present invention, it is also provided that the optical system includes an image processing unit for, in particular, dynamically generating and outputting image data defining the image content to the projector unit, the image processing unit being provided for the purpose of adapting a distortion and/or a spatial size of the image data as a function of an instantaneous setting of the optical exit pupil shifting unit, in particular, by a change of a resolution, in such a way that when a setting of the optical exit pupil shifting unit is changed, the user perceives an essentially unchanged image content. A particularly advantageous visual impression may be advantageously achieved as a result, the perceptible images remaining free of cropped edges or the like. An unchanged image content may, in particular, be shifted, expanded, compressed, etc. as a result of the spatial shift of the exit pupil, so that after an adjustment, the image content potentially strikes a changed (for example, smaller or larger) surface of the retina. The image processing unit is provided, for example, for the purpose of shifting an image line near the edge further in the direction of an image center of a maximum possible image output area by reducing a resolution, in order to prevent a change of the image area near the edge in the perception of the user. In this way, all further image lines situated further inward must also be shifted, which is achievable by a reduction of the total resolution. The image processing unit is provided, in particular, for dynamically adapting the image data based on an eye-tracking of the user eye. That the image content “remains essentially the same” is understood to mean, in particular, that the image content is free of cropped (edge) areas.

In accordance with an example embodiment of the present invention, it is additionally provided that the optical system includes an eye-tracking unit, which is provided for the purpose of detecting at least one eye movement of the eye of the user, a control unit of the optical system being configured, based on the eye movement data of the eye of the user detected by the eye-tracking unit, to dynamically adapt a setting of the optical exit pupil shifting unit in such a way that the exit pupil remains in superposition with an entrance pupil of the eye of the user. As a result, a viewing experience may be advantageously significantly improved. The effective total eye box may be significantly enlarged as a result. The eye-tracking unit may also be provided for detecting and/or determining a rate of eye movement, a pupil position, a pupil size, a viewing direction, an accommodation state and/or a fixation distance of the eye. The eye-tracking unit is designed, in particular, as one component of the virtual retinal scan display, in particular, of the optical system. Detailed designs of eye trackers are described in the related art, so that no further discussion thereof will follow at this point. It is possible that the eye tracker unit includes a monocular or a binocular eye-tracking system. The eye tracker unit is preferably integrated at least partially in a component of the data glasses, for example, in a frame of the data glasses. The eye-tracking unit includes, in particular, a control unit, which is provided for the purpose of converting eye movement data detected by the eye-tracking unit into control commands for the exit pupil shifting unit, in particular, for actuators of the exit pupil shifting unit, which move the focal lens or the first lens of the multi-lens lens system. The control unit of the eye-tracking unit is provided, in particular, for controlling actuators of the exit pupil shifting unit. A “control unit” is understood to mean, in particular, a unit that includes at least control electronics. “Control electronics” are understood to mean, in particular, a unit including a processor unit, in particular, a processor and including a memory unit, in particular, a memory chip or the like, and including an operating program stored in the memory unit and executable by the processor unit.

In accordance with an example embodiment of the present invention, data glasses including the optical system and a method for projecting image contents onto the retina of a user with the aid of the optical system are also provided, the exit pupil and, in particular, an eye box of the optical system being spatially shifted manually or in an at least semi-automated manner by an optical exit pupil shifting unit situated in an optical path of the light beam, preferably in directions which extend at least essentially in parallel to an exit pupil plane of the exit pupil. This may enable an advantageous spatial adjustability of an exit pupil position and/or of an eye box position. A viewing experience may be advantageously significantly improved. This may advantageously result in an image remaining visible even with a shifting of the data glasses or with an eye movement of the user.

The optical system according to the present invention, the data glasses according to the present invention and the method according to the present invention are not to be limited to the application and specific embodiment described above. The optical system according to the present invention, the data glasses according to the present invention, and the method according to the present invention may, in particular, include a number differing from a number of individual elements, components and units as well as method steps cited herein for fulfilling an operating principle. In addition, in the case of the value ranges indicated in this description, values also lying within the aforementioned limits are to be considered as described and as arbitrarily useable.

### BRIEF DESCRIPTION OF THE DRAWINGS

Further advantages result from the description of the figures below. Four exemplary embodiments of the present invention are represented in the figures. The figures and the description contain numerous features in combination. Those skilled in the art will purposely also view the features individually and combine them to form meaningful further combinations, in view of the disclosure herein.

FIG. 1 schematically shows data glasses according to an example embodiment of the present invention including an optical system for forming a virtual retinal display scan.

FIG. 2 shows a simplified representation of the virtual retinal scan display, in accordance with an example embodiment of the present invention.

FIG. 3 schematically shows an effect produced by an optical exit pupil shifting unit of the optical system, in accordance with an example embodiment of the present invention.

FIG. 4 schematically shows a representation of the optical system including the optical exit pupil shifting unit, in accordance with an example embodiment of the present invention.

FIG. 5 schematically shows a flowchart of a method for projecting image contents on a retina of a user with the aid of the optical system, in accordance with an example embodiment of the present invention.

FIG. 6 schematically shows a representation of an alternative optical system including an alternative optical exit pupil shifting unit, in accordance with an example embodiment of the present invention.

FIG. 7A schematically shows a representation of a multi-lens lens system of the alternative optical exit pupil shifting unit including lenses non-shifted relative to one another, in accordance with an example embodiment of the present invention.

FIG. 7B schematically shows a representation of the multi-lens lens system including lenses shifted relative to one another, in accordance with an example embodiment of the present invention.

FIG. 8 schematically shows a representation of exit pupils in an exit pupil plane of the optical system prior to and after an adjustment of the optical exit pupil shifting unit, in accordance with an example embodiment of the present invention.

FIG. 9 schematically shows a representation of image contents on a retina of the user of the optical system prior to and after an adjustment of the optical exit pupil shifting unit, in accordance with an example embodiment of the present invention.

FIG. 10 schematically shows a representation of a further alternative optical system including one further alternative optical exit pupil shifting unit, in accordance with an example embodiment of the present invention.

FIG. 11 schematically shows a representation of a second further alternative optical system including a second further alternative optical exit pupil shifting unit, in accordance with an example embodiment of the present invention.

### DETAILED DESCRIPTION OF EXAMPLE EMBODIMENTS

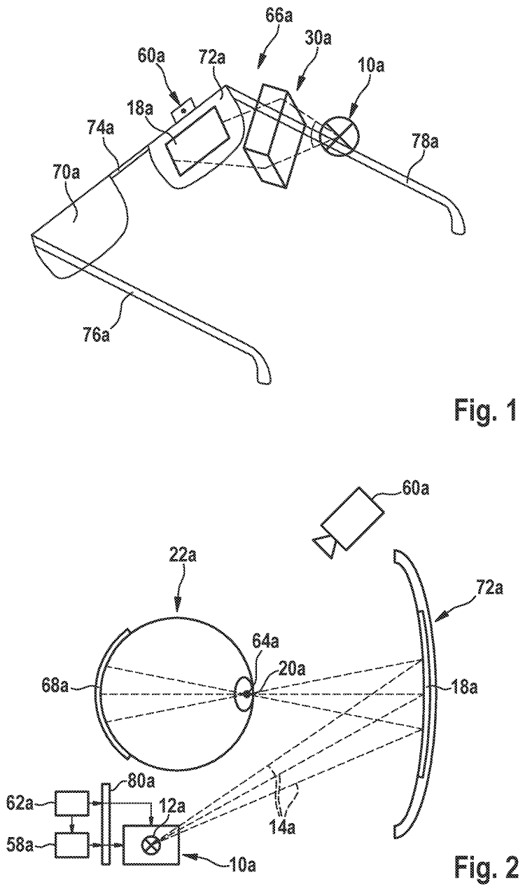

FIG. 1 schematically shows data glasses 66a. Data glasses 66a include eyeglass lenses 70a, 72a. Eyeglass lenses 70a, 72a are predominantly transparent. Data glasses 66a include an eyeglass frame 74a including frame temples 76a, 78a. Data glasses 66a include an optical system 30a. Data glasses 66a form a part of optical system 30a. Optical system 30a may include an external device, which may be designed, for example, as a smartphone (not shown). The external device may be in data communication contact with data glasses 66a. Alternatively, data glasses 66a, as shown by way of example in the figures, may also form optical system 30a in its entirety. Data glasses 66a include a control unit 62a (cf. FIG. 2). Control unit 62a may be integrated into one of frame temples 76a, 78a. Alternative arrangements of control unit 62a in data glasses 66a, for example, in an eyeglass lens edge, are also possible. Control unit 62a is provided for operating data glasses 66a, in particular, individual components of data glasses 66a, such as an eye-tracking unit 60a, an image processing unit 58a or an image source 80a (cf. FIG. 2).

Optical system 30a forms a virtual retinal scan display (cf. the highly simplified representation in FIG. 2). The virtual retinal scan display is provided for mapping an image content constructed line-by-line from a scanned light beam 14a (laser beam) on a retina 68a of an eye 22a of a user. Optical system 30a includes a projector unit 10a. Projector unit l0a includes a modulatable light source 12a. Modulatable light source 12a is provided for generating a modulated light beam 14a. Projector unit l0a includes a movable deflection device 16a for light beam 14a (see FIG. 4, among others). The scanning projection of the image content from light beam 14a is generated by the movement(s) of movable deflection device 16a. Movable deflection device 16a in FIG. 4 is designed by way of example as a combination of two 1-D MEMS mirrors.

Optical system 30a includes a diverting unit 18a. The image content is projected onto diverting unit 18a. Diverting unit 18a is integrated into one of the eyeglass lenses 70a, 72a. Diverting unit 18a is static. Diverting unit 18a is configured to map the projected image content into an exit pupil 20a of optical system 30a, in particular, into an exit pupil 20a formed by optical system 30a. Diverting unit 18a is configured to guide (deflect) light beams 14a in the direction of eye 22a of the user. For the image content to be able to be successfully projected onto retina 68a of eye 22a of the user, exit pupil 20a must overlap with an entrance pupil 64a of eye 22a of the user. Optical system 30a includes an eye-tracking unit 60a. Eye-tracking unit 60a is provided for the purpose of detecting an eye movement of eye 22a of the user. Control unit 62a of optical system 30a is configured, based on the eye movement data of eye 22a of the user detected by eye-tracking unit 60a, to dynamically adapt a setting of an optical exit pupil shifting unit 26a (cf. FIG. 4, among others) of optical system 30a in such a way that exit pupil 20 remains in superposition with the entry pupil 64a of eye 22a of the user even after eye movements of the user, in particular, even after changes of pupil positions of eye 22a of the user. Alternatively or in addition to eye-tracking unit 60a, optical system 30a could also include an adjustment device for manually adjusting (not shown) optical exit pupil shifting unit 26a. Optical system 30a includes image processing unit 58a. Image processing unit 58a is provided for dynamically generating and outputting image data defining the image content onto projector unit 10a.

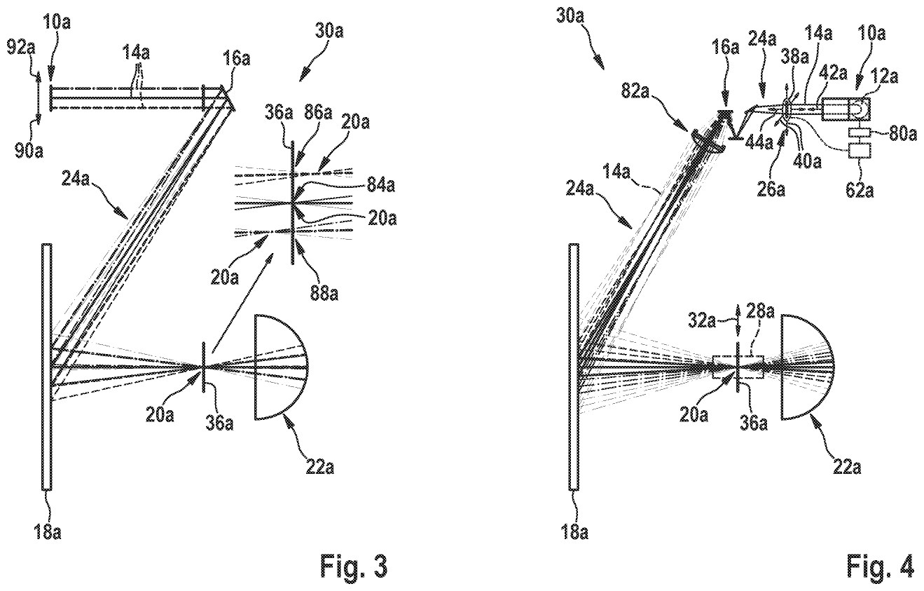

FIG. 3 schematically shows the effect achievable by optical exit pupil shifting unit 26a. Light beam 14a marked by the solid lines is non-shifted and is scanned by a movement of the movable deflection device 16a and projected onto diverting unit 18a. The three solid lines of differing thickness represent light beam 14a in three different deflection positions of movable deflection device 16a. Diverting unit 18a, in turn, maps the image generated by scanned light beam 14a in exit pupil 20a. Exit pupil 20a thus assumes a first exit pupil position 84a in an exit pupil plane 36a. Light beam 14a shifted in a first direction 90a by exit pupil shifting unit 26a is marked by the dashed lines. Shifted light beam 14a also strikes the movable deflection device and is scanned and projected onto diverting unit 18a. The three dashed lines of differing thickness represent shifted light beam 14a in the three different deflection positions of movable deflection device 16a. Diverting unit 18a maps the image generated by shifted scanned light beam 14a also in exit pupil 20a which, however, is spatially also shifted as compared to exit pupil position 84a of non-shifted light beam 14a. Exit pupil 20a in this case thus assumes a second exit pupil position 86a in exit pupil plane 36a. The shift of exit pupil 20a takes place in a direction 92a opposite to first direction 90a. Light beam 14a shifted in a second direction 92a by exit pupil shifting unit 26a is marked by the dashed-dotted lines. Light beam 14a thus shifted also strikes movable deflection device 16a and is scanned and projected onto diverting unit 18a. The three dashed-dotted lines of differing thickness represent light beam 14a thus shifted in the three different deflection positions of movable deflection device 16a. Diverting unit 18a maps the image generated by shifted scanned light beam 14a also in exit pupil 20a which, however, is spatially shifted as compared to the two previously described exit pupil positions 84a, 86a. Exit pupil 20a in this case thus assumes a third exit pupil position 88a in exit pupil plane 36a. The shift of exit pupil 20a takes place in direction 90a opposite to second direction 92a. When considering exit pupil positions 84a, 86a, 88a more closely, it becomes clear that as a result of the shift, the exact position of exit pupil 20a is shifted also slightly in propagation direction 42a of light beam 14a. The image projected onto retina 68a is thus slightly defocused. However, the defocusing effect is minimal and may be compensated for (see FIG. 4, among others).

FIG. 4 schematically shows a representation of optical system 30a including multiple exemplary optical paths 24a. Each optical path 24a is part of another setting of movable deflection device 16a. In the particular application, optical paths 24a are passed through so quickly that as a result of the inertia of eye 22a, a flat image instead of individual points is perceived. Optical system 30a includes a projection optical system 82a. Light beams 14a exit projector unit 10a through projection optical system 82a. Optical system 30a includes optical exit pupil shifting unit 26a. Optical exit pupil shifting unit 26a is provided for generating (manually or in an automated manner) a spatial shift of exit pupil 20a of optical system 30a. Exit pupil shifting unit 26a is provided for spatially shifting the position of exit pupil 20a in directions 32a, 34a in parallel to exit pupil plane 36a of exit pupil 20a. Exit pupil 20a is situated in an eye box 28a of optical system 30a. Eye box 28a is formed by an area around exit pupil 20a, in which all light beams 14a enter unimpeded into eye 22a of the user and are able to be mapped onto retina 68a. The size of eye box 28a is thus a function of a pupil setting and pupil size of eye 22a.

Optical exit pupil shifting unit 26a is situated in optical path 24a of light beam 14a. Optical exit pupil shifting unit 26a represented in the exemplary embodiment of FIG. 4 is situated in optical path 24a of light beam 14a between light source 12a and movable deflection device 16a. Optical exit pupil shifting unit 26a is designed as a single focal lens 38a. Focal lens 38a is displaceably mounted. Focal lens 38a is displaceably mounted in a plane 40a, which is extended perpendicularly to propagation direction 42a of light beam 14a before passing focus lens 38a. A spatial shift of exit pupil 20a in exit pupil plane 36a is effectuated by a shift of focal lens 38a in plane 40a. In the case of FIG. 4 represented by way of example, a shift of focal lens 38a by 0.3 m in plane 40a generates a shift of exit pupil 20a in exit pupil plane 36a of 0.88 mm.

Focal lens 38a is also displaceably mounted in a further direction 44a, which extends in parallel to propagation direction 42a of light beam 14a in front of focal lens 38a. The shift of focal lens 38a in further direction 44a serves to focus the image content mapped in exit pupil 20a. The shift of focal lens 38a in further direction 44a serves to compensate for/to offset the slight defocusing generated by the shift of focal lens 38a in plane 40a (see also FIG. 3). The defocusing by the scanning devices may also be meaningfully corrected by a movement of the focal lens along further direction 44a. Implementations are possible with a synchronization to the scanning beam direction and/or with a piece of viewing direction information by eye-tracking unit 60a.

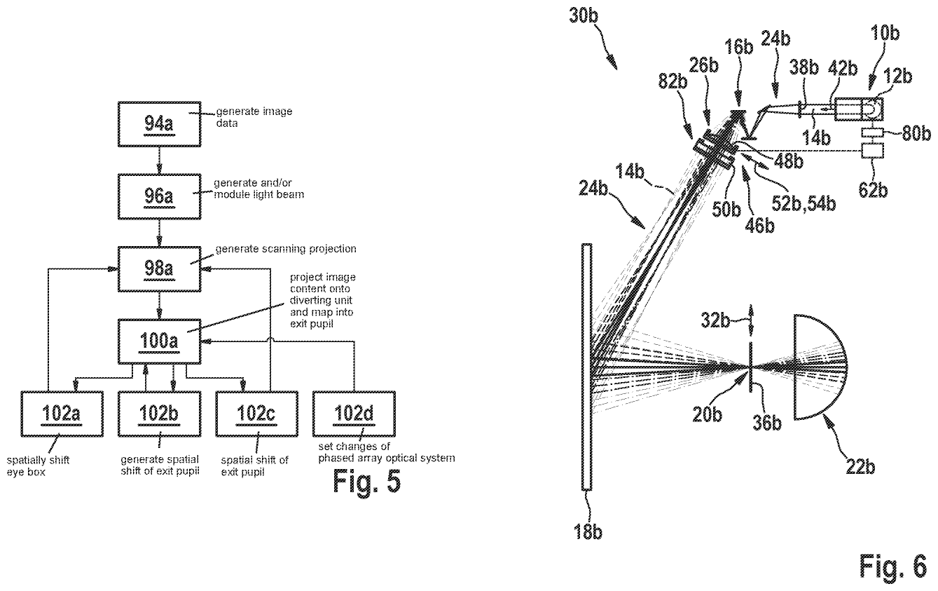

FIG. 5 schematically shows a flowchart of a method for projecting image contents on retina 68a of the user with the aid of optical system 30a. In at least one method step 94a, image data are generated by image processing unit 58a. In at least one method step 96a, a light beam 14a is generated and/or modulated by a modulatable light source 12a (laser light source/laser module), in particular, modulated, for example, color-modulated and/or brightness-modulated according to the image data received from image processing unit 58a. It is possible that a color modulation of light beam 14a is generated by a controlled superposition of monochrome laser light beams (for example, RGB). In at least one method step 98a, a scanning projection of the image content is generated from modulated light beam 14a as a result of the movement of movable deflection device 16a. In at least one method step 100a, the image content is projected onto diverting unit 18a and mapped by diverting unit 18a into exit pupil 20a. In addition, the projected image content is deflected in method step 100a onto eye 22a of the user. In at least one method step 102a, exit pupil 20a and, in particular, eye box 28a are spatially shifted manually or in an automated manner by optical exit pupil shifting unit 26a situated in beam path 24a of light beam 14a in directions 32a, 34a, which extend in parallel to exit pupil plane 36a of exit pupil 20a. The spatial shift of exit pupil 20a in method step 102a is generated by a spatial shift of focal lens 38a situated between light source 12a and movable deflection device 16a in plane 40a. In a method step 102b alternative to method step 102a, the spatial shift of exit pupil 20b may also be generated by a lateral shift of a position of a first lens 48b of a multi-lens lens system 46b relative to a second lens 50b of multi-lens lens system 46b, the multi-lens lens system 46b being situated between movable deflection device 16b and diverting unit 18b. In further method steps 102c, 102d alternative to method steps 102a, 102b, the spatial shift of exit pupil 20c, 20d may also take place by setting changes of a phased array optical system 56c, 56d situated in optical path 24c or used instead of projection unit 10d.

Three further exemplary embodiments of the present invention are shown in FIGS. 6 through 11. The following descriptions and the figures are restricted essentially to the differences between the exemplary embodiments, in terms of identically marked components, in particular, in terms of components having the identical reference numeral, reference in principle also capable of being made to the figures and/or the description of the other exemplary embodiments, for example, of FIGS. 1 through 5. To differentiate between the exemplary embodiments, the letter a is placed after the reference numerals of the exemplary embodiment in FIGS. 1 through 5. In the exemplary embodiments of FIGS. 6 through 11, the letter a is replaced by the letters b through d.

FIG. 6 schematically shows an alternative optical system 30b, which is useable, in particular, also in data glasses 66b. Optical system 30b includes a projector unit 10b generating light beams 14b, including a light source 12b and including a movable deflection device 16b. In addition, optical system 30b includes diverting unit 18b generating the exit pupils 20b, which maps the image content generated by scanned light beam 14b into an eye 22b of the user. Optical system 30b includes an optical exit pupil shifting unit 26b. Optical exit pupil shifting unit 26b is situated in an optical path 24b of light beam 14b between movable deflection device 16b and diverting unit 18b. In the case shown, optical exit pupil shifting unit 26b forms, for example, a part of a projection optical system 82b of projector unit 10b. Optical exit pupil shifting unit 26b is designed as a multi-lens lens system 46b. Multi-lens lens system 46b includes a first lens 48b. Multi-lens lens system 46b includes a second lens 50b. Second lens 50b is situated in optical path 24b of light beam 14b downstream from first lens 48b. Second lens 50b is situated in parallel to first lens 48b. Lenses 48b, 50b are designed approximately as thin lenses. First lens 48b has, for example, a focal length of approximately 34 mm. Second lens 50b has, for example, a focal length of 25 mm. Thus, multi-lens lens system 46b made up, for example, of the two lenses 48b, 50b has a focal length of 15 mm. First lens 48b of multi-lens lens system 46b is displaceably mounted in a plane 54b extending in parallel to a main extension plane 52b of first lens 48b for generating the spatial shift of exit pupil 20b.

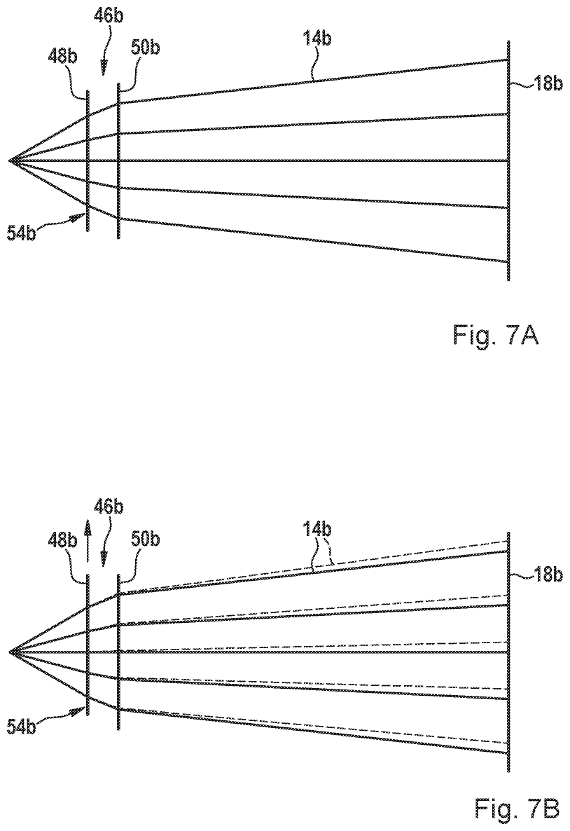

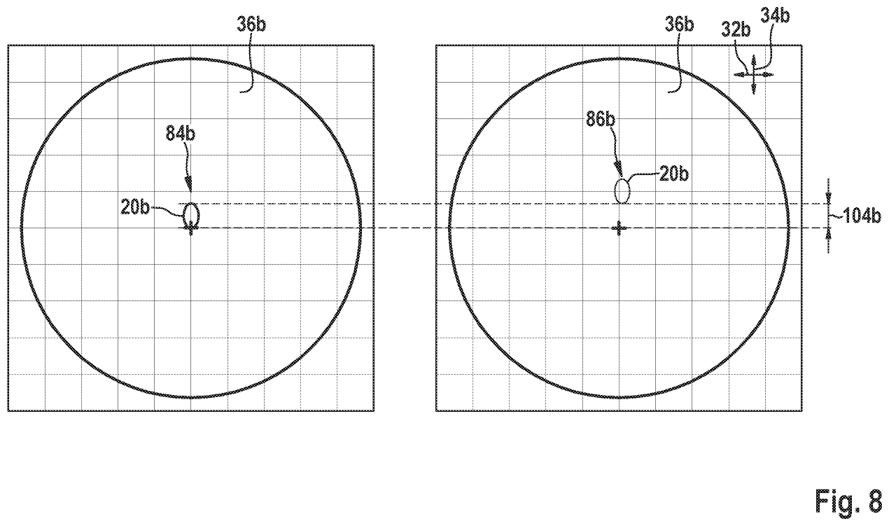

FIGS. 7A and 7B schematically illustrate the effect of the shift of first lens 48b relative to second lens 50b. In FIG. 7A, first lens 48b is represented in a non-shifted initial state. Multi-lens system 46b generates, depending on the instantaneous scan position of light beam 14b, an image on diverting unit 18b. In FIG. 7B, first lens 48b is shifted relative to second lens 50b (remaining still) in plane 54b (for example, upwardly). The solid lines each show the profiles of light beams 14b prior to the shifting of first lens 48b. Dashed light beams 14b each show the profiles of the same light beams after the shifting of first lens 48b. The image projected onto diverting unit 18b is also shifted upwardly by the shift of first lens 48b upward. In the case shown by way of example, a shift of first lens 48b by 0.5 mm generates a shift of exit pupil 20b in an exit pupil plane 36b by 0.88 mm. The left side of FIG. 8 shows by way of example, an exit pupil 20b in an exit pupil position 84b in exit pupil plane 36b prior to a shift of first lens 48b. The right side of FIG. 8 shows by way of example an exit pupil 20b in an exit pupil position 86b in exit pupil plane 36b after a shift of first lens 48b. Exit pupil 20b has been shifted by a distance 104b as a result of the shift of first lens 48b.

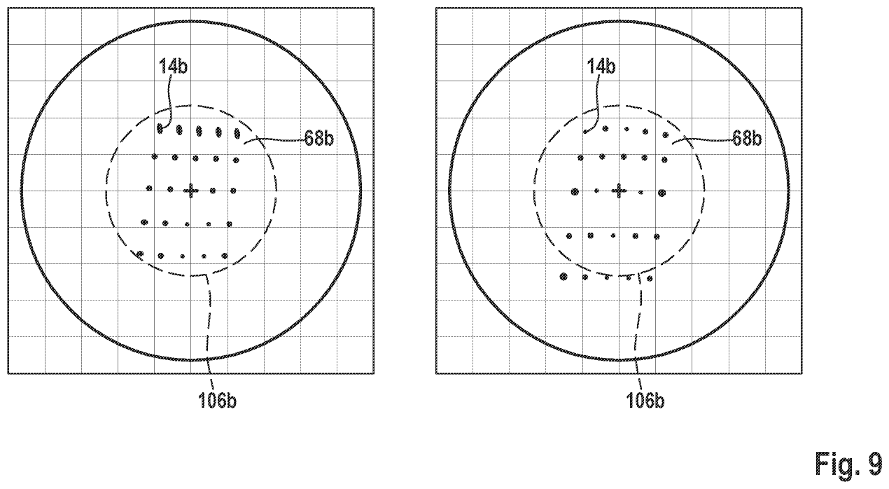

As a result of the shift of exit pupil 20b, a change of an image projected on a retina 68b of eye 22b of the user may also be generated. An effect occurring as a result is schematically represented in FIG. 9. A size of a projection of the image content on retina 68b may vary as a result of the change of optical path 24b in the area of eye 22b generated by the shift of exit pupil 20b or as a result of the distortion of the projected image content generated by the shift of the exit pupil 20b. The user would then perceive a cropped and/or resized image. Optical system 30b includes an image processing unit 58b. Image processing unit 58b is provided for the purpose of avoiding this type of image impression. To fulfill this task, image processing unit 58b is provided for the purpose of adapting the image data transferred to projector unit 10b (for example, by a change in a resolution, by a distortion and/or by an adaptation of a spatial size of the image data, etc.) as a function of an instantaneous setting of optical exit pupil shifting unit 26b in such a way that when a setting of optical exit pupil shifting unit 26b is changed, the user perceives an at least essentially unchanged image content, preferably an image content which remains two-dimensionally the same size. In order for a format of the image content to remain at least essentially the same, image processing unit 58b is provided for the purpose of adapting the image data in such a way that they are projected exclusively into an overlapping area 106b, in which all projections of image contents fit which are generatable using all meaningfully possible settings of optical system 30b (for example, the resolution during a shift is reduced in this case, so that the format of the projection appears unchanged).

It is noted that a meaningful combination of the exemplary embodiment including multi-lens lens system 46b and of the exemplary embodiment including focal lens 38a is possible.

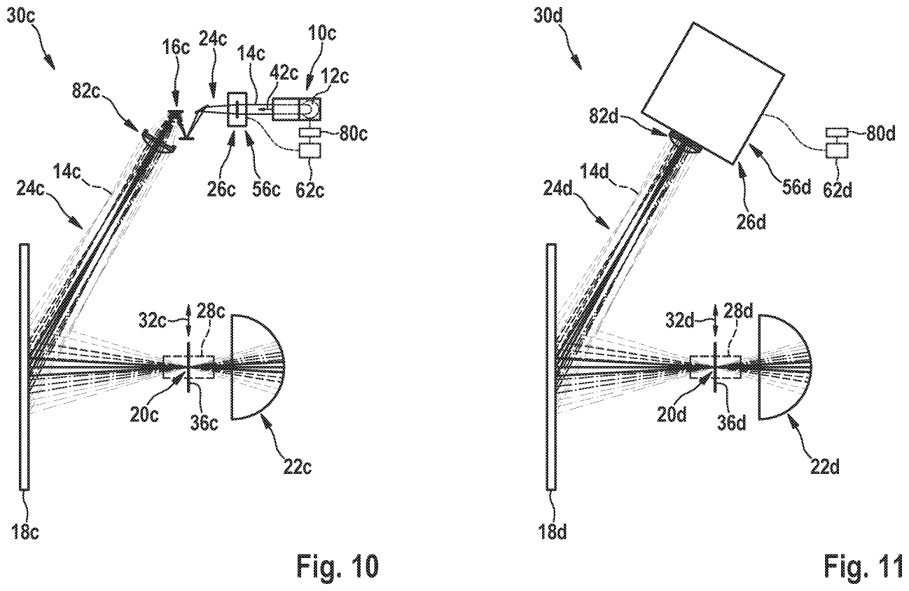

FIG. 10 schematically shows a representation of one further alternative optical system 30c. Further alternative optical system 30c includes an exit pupil shifting unit 26c designed as phase array optical system 56c. By contrast with optical system 30a from FIGS. 1 through 5, focal lens 38a is replaced by phased array optical system 56c, i.e., in particular, situated in front of a movable deflection device 16c of a projector unit 10c of optical system 30c. Phase array optical system 56c is activatable by a control unit 62c of optical system 30c or by data glasses 66c including optical system 30c. Alternatively or in addition, it is also possible that phased array optical system 56c replaces multi-lens lens system 46b of FIGS. 6 through 7B, i.e., in particular, is situated behind movable deflection device 16c of projector unit 10c of optical system 30c.

FIG. 11 schematically shows a representation of a second further alternative optical system 30d. Second further alternative optical system 30d includes an exit pupil shifting unit 26d designed as phased array optical system 56d. By contrast with optical system 30a, 30b from FIGS. 1 through 9, entire projector unit 10a, 10b is replaced by phased array optical system 56d. Thus, phased array optical system 56d forms both projector unit 10d and exit pupil shifting unit 26d.

What is claimed is:

1. An optical system for a virtual retinal scan display, comprising:
a projector unit including a modulatable light source configured to generate at least one modulated light beam and including a movable deflection device for the at least one light beam, a scanning projection of an image content being generatable from the at least one light beam as a result of movement of the movable deflection device;
a diverting unit, onto which the image content is projectable and which is configured to map the projected image content into an exit pupil and to guide it onto an eye of a user; and
an optical exit pupil shifting unit situated in an optical path of the light beam configured to spatially shift the exit pupil manually or in an at least semi-automated manner, of an eye box of optical system.

2. The optical system as recited in claim 1, wherein the optical exit pupil shifting unit is configured to shift the exit pupil in directions which extend at least essentially in parallel to an exit pupil plane of the exit pupil.

3. The optical system as recited in claim 1, wherein the optical exit pupil shifting unit is situated in the optical path of the light beam between the light source and the movable deflection device.

4. The optical system as recited in claim 1, wherein the optical exit pupil shifting unit is a single focal lens.

5. The optical system as recited in claim 4, wherein the focal lens is displaceably mounted for generating the spatial shift of the exit pupil in at least one plane, which is extended at least essentially perpendicularly to a propagation direction of the light beam in front of the focal lens.

6. The optical system as recited in claim 4, wherein the focal lens is displaceably mounted for focusing the image content mapped in the exit pupil at least in a direction which extends essentially in parallel to a propagation direction of the light beam in front of the focal lens.

7. The optical system as recited in claim 1, wherein the optical exit pupil shifting unit is situated in the optical path of the light beam between the movable deflection device and the diverting unit.

8. The optical system as recited in claim 1, wherein the optical exit pupil shifting unit is a multi-lens lens system including at least one first lens and including at least one second lens, the second lens being situated in the optical path of the light beam downstream from the first lens and in parallel to the first lens.

9. The optical system as recited in claim 8, wherein the first lens of the multi-lens lens system is displaceably mounted at least in a plane extending at least essentially in parallel to a main extension plane of the first lens for generating the spatial shift of the exit pupil.

10. The optical system as recited in claim 1, wherein the optical exit pupil shifting unit is a phased array optical system.

11. The optical system as recited in claim 1, further comprising:
an image processing unit configured to dynamically generate and output image data defining the image content to the projector unit, the image processing unit configured to adapt the image data as a function of an instantaneous setting of the optical exit pupil shifting unit by a change of a resolution, a distortion and/or a spatial size of the image data, in such a way that when a setting of optical exit pupil shifting unit is changed, the user perceives an at least essentially unchanged image content.

12. The optical system as recited in claim 1, further comprising:
an eye-tracking unit configured to detect at least one eye movement of the eye of the user, a control unit of the optical system being configured, based on eye movement data of the eye detected by the eye-tracking unit, to dynamically adapt a setting of the optical exit pupil shifting unit in such a way that the exit pupil remains in superposition with an entrance pupil of the eye of the user.

13. Data glasses including an optical system for a virtual retinal scan display, the optical system comprising:
a projector unit including a modulatable light source configured to generate at least one modulated light beam and including a movable deflection device for the at least one light beam, a scanning projection of an image content being generatable from the at least one light beam as a result of movement of the movable deflection device;
a diverting unit, onto which the image content is projectable and which is configured to map the projected image content into an exit pupil and to guide it onto an eye of a user; and
an optical exit pupil shifting unit situated in an optical path of the light beam configured to spatially shift the exit pupil manually or in an at least semi-automated manner, of an eye box of optical system.

14. A method for projecting image contents on a retina of a user using an optical system, the method comprising:
generating by a projector unit of the optical system at least one modulated light beam by a modulatable light source of the projector unit, and generating a scanning projection of an image content from the at least one light beam, using a movable deflection device of the projector unit, by moving the movable deflection device, the image content being projected onto a diverting unit;
mapping, using the diverting unit, the projected image content into an exit pupil, and deflecting the projected image content onto an eye of a user; and
spatially shifting an eye box of the optical system, manually or in an at least a semi-automated manner, by an optical exit pupil shifting unit situated in a beam path of the light beam.

15. The method as recited in claim 13, wherein the eyebox is spatially shifted in directions which extend at least essentially in parallel to an exit pupil plane of the exit pupil.
